(19) United States
(12) Patent Application Publication
(10) Pub. No.: US 2015/0258772 A1
(43) Pub. Date: Sep. 17, 2015

(54) MULTI-STATION FLEXOGRAPHIC PRINTING SYSTEM FOR PATTERNED COATING DEPOSITION

(71) Applicant: Uni-Pixel Displays, Inc., The Woodlands, TX (US)

(72) Inventors: Danliang Jin, The Woodlands, TX (US); Gregory W. Webb, Spring, TX (US); Zhengwei Shi, Spring, TX (US); Xuanqi Zhang, Spring, TX (US); Robert J. Petcavich, The Woodlands, TX (US)

(21) Appl. No.: 14/727,843

(22) Filed: Jun. 1, 2015

Related U.S. Application Data
(63) Continuation-in-part of application No. 14/727,818, filed on Jun. 1, 2015.
Application No. 14/727,818 is a continuation-in-part of application No. 14/354,507, filed on Aug. 5, 2014.
Application No. 14/727,818 is a continuation-in-part of application No. 14/354,526, filed on Apr. 25, 2014.
(60) Provisional application No. 61/551,009, filed on Oct. 25, 2011.
(60) Provisional application No. 61/551,030, filed on Oct. 25, 2011.

(51) Int. Cl. B41F 5/24

(52) U.S. Cl. CPC B41F 5/24

(57) ABSTRACT

A method of depositing a patterned coating in a multi-station flexographic printing system includes printing a coating in a pattern on a roll-to-roll substrate material with a first flexographic printing station, routing the printed roll-to-roll substrate material from the first flexographic printing station to a subsequent flexographic printing station, and curing the printed roll-to-roll substrate material at the subsequent flexographic printing station.

### CROSS-REFERENCE TO RELATED APPLICATIONS

This application is a continuation-in-part of U.S. patent application Ser. No. 14/727,818, filed on Jun. 1, 2015, which is hereby incorporated by reference in its entirety. U.S. patent application Ser. No. 14/727,818 is a continuation-in-part of U.S. patent application Ser. No. 14/354,507, filed on Aug. 5, 2014, which is a national phase entry of PCT International Application PCT/US2012/042050, filed on Jun. 12, 2012, which claims the benefit of, or priority to, U.S. Provisional Patent Application Ser. No. 61/551,009, filed on Oct. 25, 2011, and is also a continuation-in-part of U.S. patent application Ser. No. 14/354,526, filed on Apr. 25, 2014, which is a national phase entry of PCT International Application PCT/US2012/061602, filed on Oct. 24, 2012, which claims the benefit of, or priority to, U.S. Provisional Patent Application Ser. No. 61/551,030, filed on Oct. 25, 2011, all of which are hereby incorporated by reference in their entirety.

### BACKGROUND OF THE INVENTION

A touch screen enabled system allows a user to control various aspects of the system by touch or gestures on the screen. A user may interact directly with one or more objects depicted on a display device by touch or gestures that are sensed by a touch sensor. The touch sensor typically includes a conductive pattern disposed on a transparent substrate configured to sense touch. Touch screens are commonly used in consumer, commercial, and industrial systems.

### BRIEF SUMMARY OF THE INVENTION

According to one aspect of one or more embodiments of the present invention, a method of depositing a patterned coating in a multi-station flexographic printing system includes printing a coating in a pattern on a roll-to-roll substrate material with a first flexographic printing station, routing the printed roll-to-roll substrate material from the first flexographic printing station to a subsequent flexographic printing station, and curing the printed roll-to-roll substrate material at the subsequent flexographic printing station.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled system in accordance with one or more embodiments of the present invention.

FIG. 3 shows a functional representation of a touch sensor in accordance with one or more embodiments of the present invention.

FIG. 4 shows a cross-section of a touch sensor with conductive patterns disposed on opposing sides of a transparent substrate in accordance with one or more embodiments of the present invention.

FIG. 5A shows a first conductive pattern disposed on a transparent substrate in accordance with one or more embodiments of the present invention.

FIG. 5B shows a second conductive pattern disposed on a transparent substrate in accordance with one or more embodiments of the present invention.

FIG. 5C shows a mesh area of a touch sensor in accordance with one or more embodiments of the present invention.

FIG. 6 shows a flexographic printing station in accordance with one or more embodiments of the present invention.

FIG. 7 shows a schematic of a multi-station flexographic printing system in accordance with one or more embodiments of the present invention.

FIG. 8 shows a roll-to-roll substrate material path in a multi-station flexographic printing system in accordance with one or more embodiments of the present invention.

FIG. 9A shows a modified roll-to-roll substrate material path in a multi-station flexographic printing system for patterned coating deposition in accordance with one or more embodiments of the present invention.

FIG. 9B shows a modified roll-to-roll substrate material path in a multi-station flexographic printing system for patterned coating deposition with an optional infrared heater in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

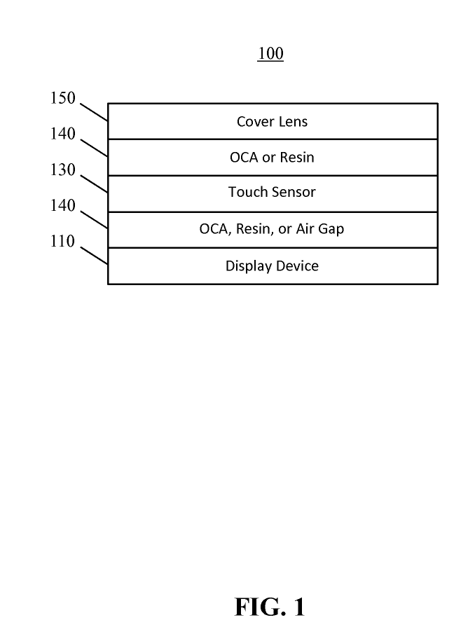

FIG. 1 shows a cross-section of a touch screen 100 in accordance with one or more embodiments of the present invention. Touch screen 100 includes a display device 110 and a touch sensor 130 that overlays at least a portion of a viewable area of display device 110. In certain embodiments, an optically clear adhesive (“OCA”) or optically clear resin (“OCR”) 140 may bond a bottom side of touch sensor 130 to a top, or user-facing, side of display device 110. In other embodiments, an isolation layer or air gap 140 may separate the bottom side of touch sensor 130 from the top, or user-facing, side of display device 110. A transparent cover lens 150 may overlay a top, or user-facing, side of touch sensor 130. The transparent cover lens 150 may be composed of polyester, glass, or any other material suitable for use as a cover lens 150. In certain embodiments, an OCA or OCR 140 may bond a bottom side of the transparent cover lens 150 to the top, or user-facing, side of touch sensor 130. A top side of transparent cover lens 150 faces the user and protects the underlying components of touch screen 100. One of ordinary skill in the art will recognize that the components and/or the stack up of touch screen 100 may vary based on an application or design in accordance with one or more embodiments of the present invention. One of ordinary skill in the art will recognize that touch sensor 130, or the function that it implements, may be integrated into the display device 110 stack up (not independently illustrated) in accordance with one or more embodiments of the present invention.

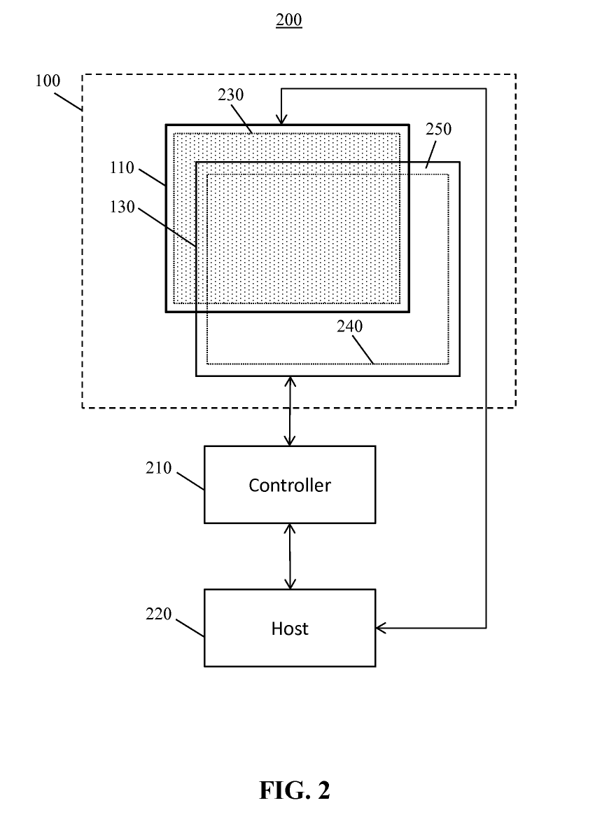

FIG. 2 shows a schematic view of a touch screen enabled system 200 in accordance with one or more embodiments of the present invention. Touch screen enabled system 200 may be a consumer, commercial, or industrial system including, but not limited to, a smartphone, tablet computer, laptop computer, desktop computer, server computer, printer, monitor, television, appliance, application specific device, kiosk, automatic teller machine, copier, desktop phone, automotive display system, portable gaming device, gaming console, or other application or design suitable for use with touch screen 100.

Touch screen enabled system 200 may include one or more printed circuit boards or flexible circuits (not shown) on which one or more processors (not shown), system memory (not shown), and other system components (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). System 200 may include one or more input/output devices (not shown), one or more local storage devices (not shown) including solid-state memory, a fixed disk drive, a fixed disk drive array, or any other non-transitory computer readable medium, a network interface device (not shown), and/or one or more network storage devices (not shown) including a network-attached storage device or a cloud-based storage device.

In certain embodiments, touch screen 100 may include touch sensor 130 that overlays at least a portion of a viewable area 230 of display device 110. Touch sensor 130 may include a viewable area 240 that corresponds to that portion of the touch sensor 130 that overlays the light emitting pixels (not shown) of display device 110 (e.g., viewable area 230 of display device 110). Touch sensor 130 may include a bezel circuit 250 outside at least one side of the viewable area 240 that provides connectivity between touch sensor 130 and a controller 210. In other embodiments, touch sensor 130, or the function that it implements, may be integrated into display device 110 (not independently illustrated). Controller 210 electrically drives at least a portion of touch sensor 130. Touch sensor 130 senses touch (capacitance, resistance, optical, acoustic, or other technology) and conveys information corresponding to the sensed touch to controller 210.

The manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and respond in an appropriate manner. In this way, the user may interact with touch screen enabled system 200 by touch or gestures on touch screen 100. In certain embodiments, host 220 may be the one or more printed circuit boards (not shown) or flexible circuits (not shown) on which the one or more processors (not shown) are disposed. In other embodiments, host 220 may be a subsystem (not shown) or any other part of system 200 (not shown) that is configured to interface with display device 110 and controller 210. One of ordinary skill in the art will recognize that the components and the configuration of the components of touch screen enabled system 200 may vary based on an application or design in accordance with one or more embodiments of the present invention.

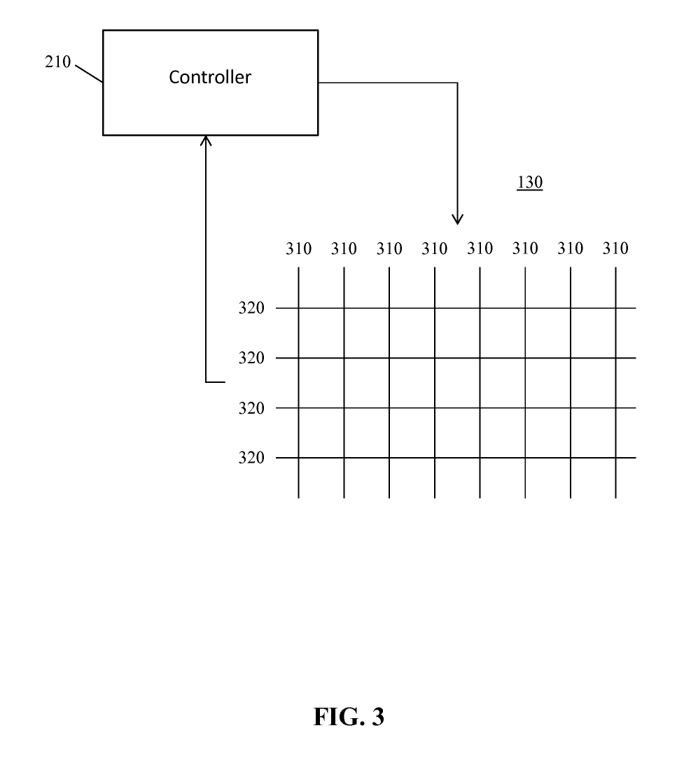

FIG. 3 shows a functional representation of a touch sensor 130 as part of a touch screen (e.g., 100 of FIG. 2) in accordance with one or more embodiments of the present invention. In certain embodiments, touch sensor 130 may be viewed as a plurality of column channels 310 and a plurality of row channels 320. The plurality of column channels 310 and the plurality of row channels 320 may be separated from one another by, for example, a dielectric or substrate (not shown) on which they are disposed. The number of column channels 310 and the number of row channels 320 may or may not be the same and may vary based on an application or a design. The apparent intersections of column channels 310 and row channels 320 may be viewed as uniquely addressable locations of touch sensor 130. In operation, controller 210 may electrically drive one or more row channels 320 and touch sensor 130 may sense touch on one or more column channels 310 that are sampled by controller 210. One of ordinary skill in the art will recognize that the role of row channels 320 and column channels 310 may be reversed such that controller 210 electrically drives one or more column channels 310 and touch sensor 130 senses touch on one or more row channels 320 that are sampled by controller 210.

In certain embodiments, controller 210 may interface with touch sensor 130 by a scanning process. In such an embodiment, controller 210 may electrically drive a selected row channel 320 (or column channel 310) and sample all column channels 310 (or row channels 320) that intersect the selected row channel 320 (or the selected column channel 310) by sensing, for example, changes in capacitance. The change in capacitance may be used to determine the location of the touch or touches. This process may be continued through all row channels 320 (or all column channels 310) such that changes in capacitance are measured at each uniquely addressable location of touch sensor 130 at predetermined intervals. Controller 210 may allow for the adjustment of the scan rate depending on the needs of a particular application or design. In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

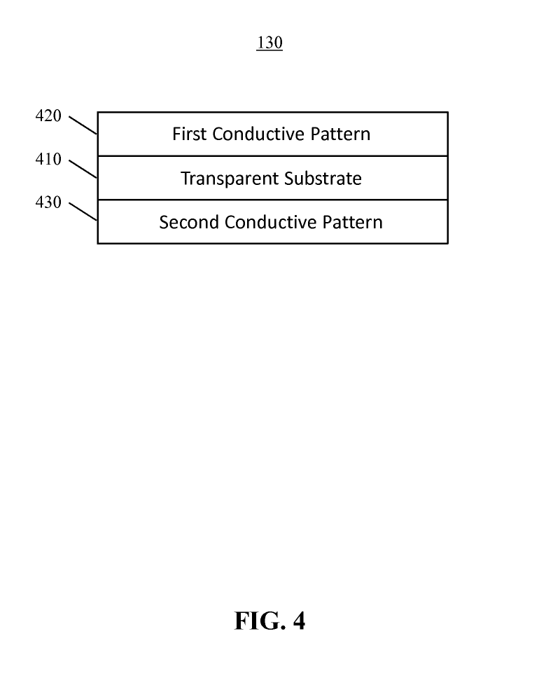

FIG. 4 shows a cross-section of a touch sensor 130 with conductive patterns 420 and 430 disposed on opposing sides of a transparent substrate 410 in accordance with one or more embodiments of the present invention. In certain embodiments, touch sensor 130 may include a first conductive pattern 420 disposed on a top, or user-facing, side of a transparent substrate 410 and a second conductive pattern 430 disposed on a bottom side of the transparent substrate 410. The first conductive pattern 420 and the second conductive pattern 430 may include different, substantially similar, or identical patterns of conductors depending on the application or design. The first conductive pattern 420 may overlay the second conductive pattern 430 at a predetermined alignment that may include an offset. One of ordinary skill in the art will recognize that a conductive pattern may be any shape or pattern of one or more conductors (not shown) in accordance with one or more embodiments of the present invention. One of ordinary skill in the art will also recognize that any type of touch sensor 130 conductor, including, for example, metal conductors, metal mesh conductors, indium tin oxide (“ITO”) conductors, poly(3,4-ethylenedioxythiophene (“PEDOT”) conductors, carbon nanotube conductors, silver nanowire conductors, or any other conductors may be used in accordance with one or more embodiments of the present invention.

One of ordinary skill in the art will recognize that other touch sensor 130 stack ups (not shown) may be used in accordance with one or more embodiments of the present invention. For example, single-sided touch sensor 130 stack ups may include conductors disposed on a single side of a substrate 410 where conductors that cross are isolated from one another by a dielectric material (not shown), such as, for example, as used in On Glass Solution (“OGS”) touch sensor 130 embodiments. Double-sided touch sensor 130 stack ups may include conductors disposed on opposing sides of the same substrate 140 (as shown in FIG. 4) or bonded touch sensor 130 embodiments (not shown) where conductors are disposed on at least two different sides of at least two different substrates 410. Bonded touch sensor 130 stack ups may include, for example, two single-sided substrates 410 bonded together (not shown), one double-sided substrate 410 bonded to a single-sided substrate 410 (not shown), or a double-sided substrate 410 bonded to another double-sided substrate 410 (not shown). One of ordinary skill in the art will recognize that other touch sensor 130 stack ups, including those that vary in the number, type, organization, and/or configuration of substrate(s) and/or conductive pattern(s) are within the scope of one or more embodiments of the present invention. One of ordinary skill in the art will also recognize that one or more of the above-noted touch sensor 130 stack ups may be used in applications where touch sensor 130 is integrated into display device 110 in accordance with one or more embodiments of the present invention.

A conductive pattern 420 or 430 may be disposed on one or more transparent substrates 410 by any process suitable for disposing conductive lines or features on a substrate. Suitable processes may include, for example, printing processes, vacuum-based deposition processes, solution coating processes, or cure/etch processes that either form conductive lines or features on substrate or form seed lines or features on substrate that may be further processed to form conductive lines or features on substrate. Printing processes may include flexographic printing processes, including the flexographic printing of a catalytic ink that may be metallized by an electroless plating process to plate a metal on top of the printed catalytic ink or direct flexographic printing of conductive ink or other materials capable of being flexographically printed, gravure printing, inkjet printing, rotary printing, or stamp printing. Deposition processes may include pattern-based deposition, chemical vapor deposition, electro deposition, epitaxy, physical vapor deposition, or casting. Cure/etch processes may include optical or Ultra-Violet (“UV”)-based photolithography, e-beam/ion-beam lithography, x-ray lithography, interference lithography, scanning probe lithography, imprint lithography, or magneto lithography. One of ordinary skill in the art will recognize that any process or combination of processes, suitable for disposing conductive lines or features on substrate, may be used in accordance with one or more embodiments of the present invention.

With respect to transparent substrate 410, transparent means capable of transmitting a substantial portion of visible light through the substrate suitable for a given touch sensor application or design. In typical touch sensor applications, transparent means transmittance of at least 85 percent of incident visible light through the substrate. However, one of ordinary skill in the art will recognize that other transmittance values may be desirable for other touch sensor applications or designs. In certain embodiments, transparent substrate 410 may be polyethylene terephthalate (“PET”), polyethylene naphthalate (“PEN”), cellulose acetate (“TAC”), cycloaliphatic hydrocarbons (“COP”), polymethylmethacrylates (“PMMA”), polyimide (“PI”), bi-axially-oriented polypropylene (“BOPP”), polyester, polycarbonate, glass, copolymers, blends, or combinations thereof. In other embodiments, transparent substrate 410 may be any other transparent material suitable for use as a touch sensor substrate. One of ordinary skill in the art will recognize that the composition of transparent substrate 410 may vary based on an application or design in accordance with one or more embodiments of the present invention.

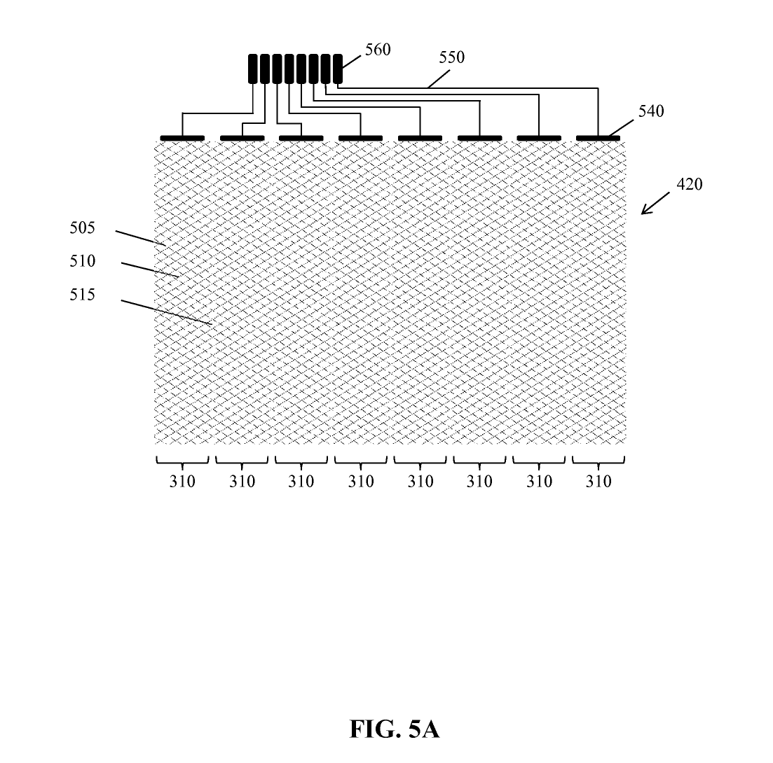

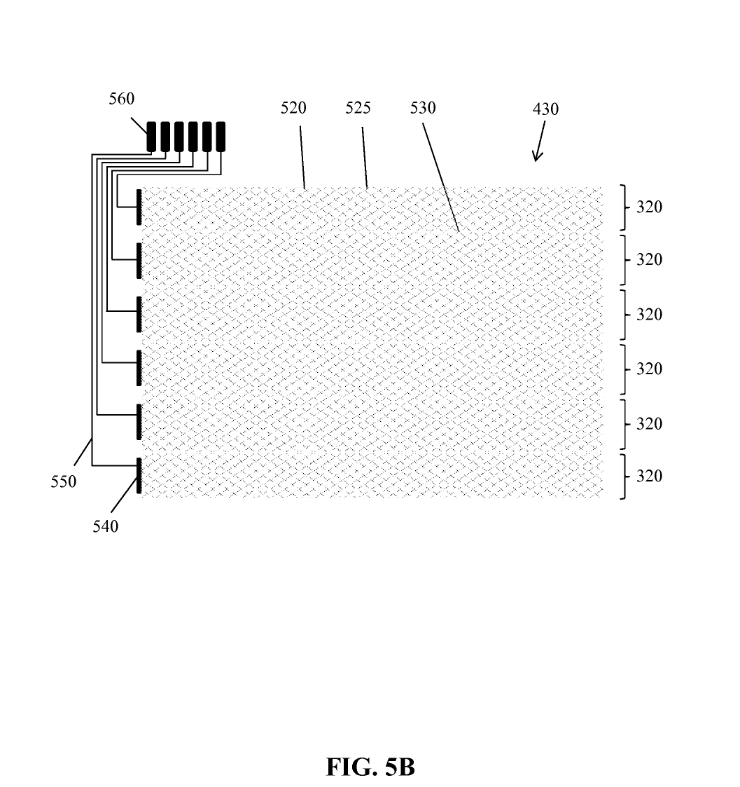

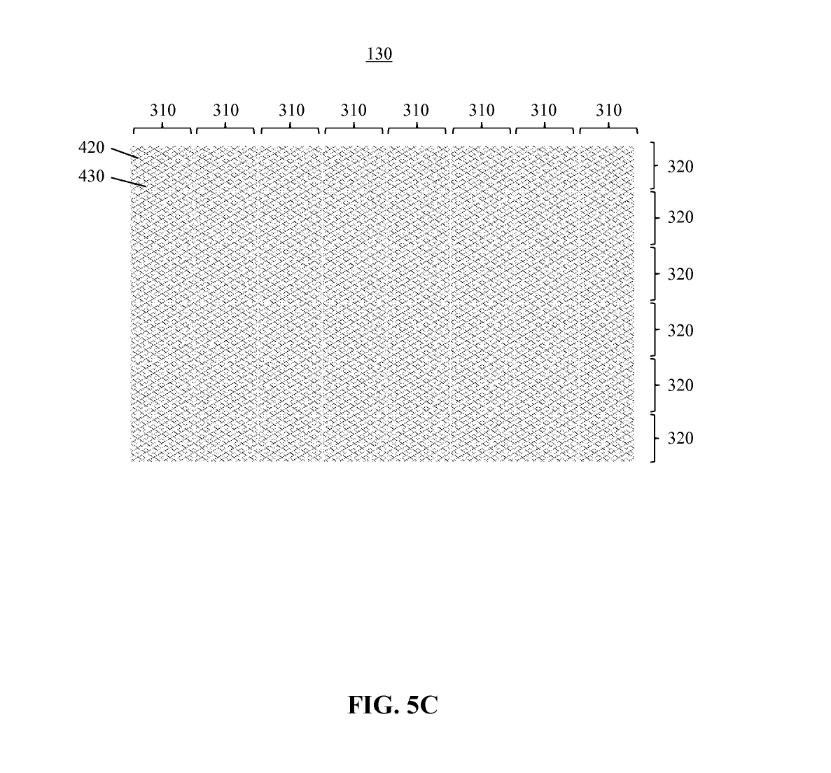

FIG. 5A shows a first conductive pattern 420 disposed on a transparent substrate (e.g., transparent substrate 410) in accordance with one or more embodiments of the present invention. In certain embodiments, first conductive pattern 420 may include a mesh formed by a first plurality of parallel conductive lines oriented in a first direction 505 and a first plurality of parallel conductive lines oriented in a second direction 510 that are disposed on a side of a transparent substrate (e.g., transparent substrate 410). One of ordinary skill in the art will recognize that the number of parallel conductive lines oriented in the first direction 505 and/or the number of parallel conductive lines oriented in the second direction 510 may or may not be the same and may vary based on an application or design. One of ordinary skill in the art will also recognize that a size of first conductive pattern 420 may vary based on an application or a design. In other embodiments, first conductive pattern 420 may include any other shape or pattern (not independently illustrated) formed by one or more conductive lines or features. One of ordinary skill in the art will recognize that first conductive pattern 420 is not limited to parallel conductive lines and may comprise any one or more of a predetermined orientation of line segments, a random orientation of line segments, curved line segments, conductive particles, polygons, or any other shape(s) or pattern(s) (not independently illustrated) comprised of electrically conductive material in accordance with one or more embodiments of the present invention.

In certain embodiments, the first plurality of parallel conductive lines oriented in the first direction 505 may be perpendicular to the first plurality of parallel conductive lines oriented in the second direction 510, thereby forming a rectangle or square-type mesh (not shown). In other embodiments, the first plurality of parallel conductive lines oriented in the first direction 505 may be angled relative to the first plurality of parallel conductive lines oriented in the second direction 510, thereby forming a parallelogram or diamond-type mesh. One of ordinary skill in the art will recognize that the relative angle between the first plurality of parallel conductive lines oriented in the first direction 505 and the first plurality of parallel conductive lines oriented in the second direction 510 may vary based on an application or a design in accordance with one or more embodiments of the present invention.

In certain embodiments, a first plurality of channel breaks 515 may partition first conductive pattern 420 into a plurality of column channels 310, each electrically isolated from the others (no electrical continuity between channels 310). One of ordinary skill in the art will recognize that the number of channel breaks 515, the number of column channels 310, and/or the width of the column channels 310 may vary based on an application or design in accordance with one or more embodiments of the present invention. Each column channel 310 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5B shows a second conductive pattern 430 disposed on a transparent substrate (e.g., transparent substrate 410) in accordance with one or more embodiments of the present invention. In certain embodiments, second conductive pattern 430 may include a mesh formed by a second plurality of parallel conductive lines oriented in a first direction 520 and a second plurality of parallel conductive lines oriented in a second direction 525 that are disposed on a side of a transparent substrate (e.g., transparent substrate 410). One of ordinary skill in the art will recognize that the number of parallel conductive lines oriented in the first direction 520 and/or the number of parallel conductive lines oriented in the second direction 525 may vary based on an application or design. The second conductive pattern 430 may be substantially similar in size to the first conductive pattern 420. One of ordinary skill in the art will recognize that a size of the second conductive pattern 430 may vary based on an application or a design. In other embodiments, second conductive pattern 430 may include any other shape or pattern (not independently illustrated) formed by one or more conductive lines or features. One of ordinary skill in the art will also recognize that second conductive pattern 430 is not limited to parallel conductive lines and could be any one or more of a predetermined orientation of line segments, a random orientation of line segments, curved line segments, conductive particles, polygons, or any other shape(s) or pattern(s) (not independently illustrated) comprised of electrically conductive material in accordance with one or more embodiments of the present invention.

In certain embodiments, the second plurality of parallel conductive lines oriented in the first direction 520 may be perpendicular (not shown) to the second plurality of parallel conductive lines oriented in the second direction 525, thereby forming a rectangle or square-type mesh (not shown). In other embodiments, the second plurality of parallel conductive lines oriented in the first direction 520 may be angled relative to the second plurality of parallel conductive lines oriented in the second direction 525, thereby forming a parallelogram or diamond-type mesh. One of ordinary skill in the art will recognize that the relative angle between the second plurality of parallel conductive lines oriented in the first direction 520 and the second plurality of parallel conductive lines oriented in the second direction 525 may vary based on an application or a design in accordance with one or more embodiments of the present invention.

In certain embodiments, a plurality of channel breaks 530 may partition second conductive pattern 430 into a plurality of row channels 320, each electrically isolated from the others (no electrical continuity). One of ordinary skill in the art will recognize that the number of channel breaks 530, the number of row channels 320, and/or the width of the row channels 320 may vary based on an application or design in accordance with one or more embodiments of the present invention. Each row channel 320 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5C shows a mesh area of a touch sensor 130 in accordance with one or more embodiments of the present invention. In certain embodiments, a touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate (e.g., transparent substrate 410). In other embodiments, a touch sensor 130 may be formed, for example, by disposing a first conductive pattern 420 on a side of a first transparent substrate (e.g., transparent substrate 410), disposing a second conductive pattern 430 on a side of a second transparent substrate (e.g., transparent substrate 410), and bonding the first transparent substrate to the second transparent substrate. One of ordinary skill in the art will recognize that the disposition of the conductive pattern or patterns may vary based on the touch sensor 130 stack up in accordance with one or more embodiments of the present invention. In embodiments that use two conductive patterns, the first conductive pattern 420 and the second conductive pattern 430 may be offset vertically, horizontally, and/or angularly relative to one another. The offset between the first conductive pattern 420 and the second conductive pattern 430 may vary based on an application or a design. One of ordinary skill in the art will recognize that the first conductive pattern 420 and the second conductive pattern 430 may be disposed on substrate or substrates 410 using any process or processes suitable for disposing the conductive patterns on the substrate or substrates 410 in accordance with one or more embodiments of the present invention.

In certain embodiments, the first conductive pattern 420 may include a first plurality of parallel conductive lines oriented in a first direction (e.g., 505 of FIG. 5A) and a first plurality of parallel conductive lines oriented in a second direction (e.g., 510 of FIG. 5A) that form a mesh that is partitioned by a first plurality of channel breaks (e.g., 515 of FIG. 5A) into electrically partitioned column channels 310. In certain embodiments, the second conductive pattern 430 may include a second plurality of parallel conductive lines oriented in a first direction (e.g., 520 of FIG. 5B) and a second plurality of parallel conductive lines oriented in a second direction (e.g., 525 of FIG. 5B) that form a mesh that is partitioned by a second plurality of channel breaks (e.g., 530 of FIG. 5B) into electrically partitioned row channels 320. In operation, a controller (e.g., 210 of FIG. 2) may electrically drive one or more row channels 320 (or column channels 310) and touch sensor 130 senses touch on one or more column channels 310 (or row channels 320). In other embodiments, the disposition and/or the role of the first conductive pattern 420 and the second conductive pattern 430 may be reversed.

In certain embodiments, one or more of the plurality of parallel conductive lines oriented in the first direction (e.g., 505 of FIG. 5A, 520 of FIG. 5B) and one or more of the plurality of parallel conductive lines oriented in the second direction (e.g., 510 of FIG. 5A, 525 of FIG. 5A) may have a line width that varies based on an application or design, including, for example, micrometer-fine line widths. In addition, the number of parallel conductive lines oriented in the first direction (e.g., 505 of FIG. 5A, 520 of FIG. 5B), the number of parallel conductive lines oriented in the second direction (e.g., 510 of FIG. 5A, 525 of FIG. 5B), and the line-to-line spacing between them may vary based on an application or a design. One of ordinary skill in the art will recognize that the size, configuration, and design of each conductive pattern 420, 430 may vary based on an application or a design in accordance with one or more embodiments of the present invention. One of ordinary skill in the art will also recognize that touch sensor 130 depicted in FIG. 5C is illustrative but not limiting and that the size, shape, and design of the touch sensor 130 is such that there is substantial transmission of an image (not shown) of an underlying display device (e.g., 110 of FIG. 1) in actual use that is not shown in the drawing.

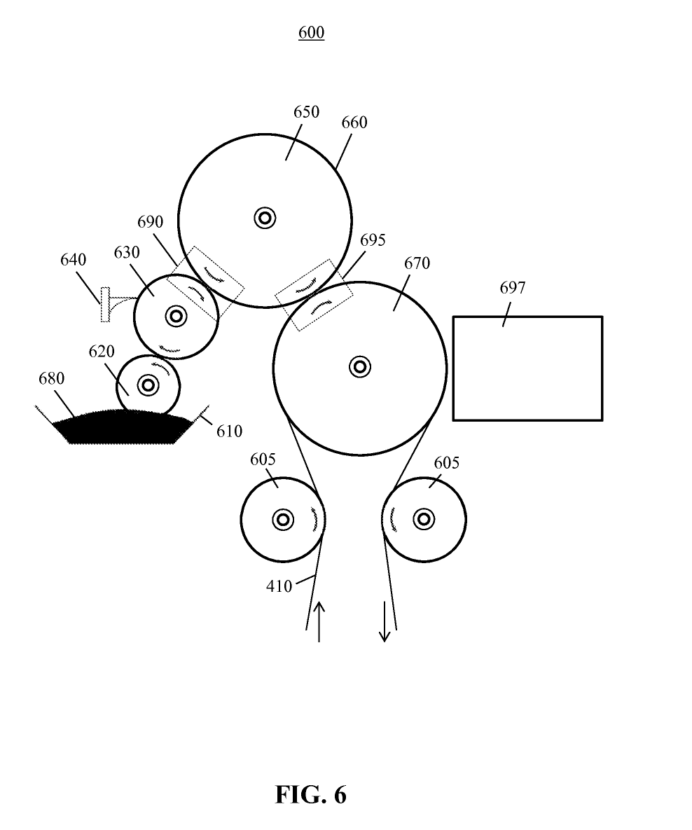

FIG. 6 shows a flexographic printing station 600 in accordance with one or more embodiments of the present invention. Flexographic printing station 600 may include an ink pan 610, an ink roll 620 (also referred to as a fountain roll), an anilox roll 630 (also referred to as a meter roll), a doctor blade 640, a printing plate cylinder 650, a flexographic printing plate 660, and an impression cylinder 670 configured to print on a transparent substrate 410 material that moves through the station 600.

In operation, ink roll 620 rotates transferring ink 680 from ink pan 610 to counter rotating anilox roll 630. Anilox roll 630 may be constructed of a rigid cylinder that includes a curved contact surface about the body of the cylinder that contains a plurality of dimples, also referred to as cells (not shown), that hold and transfer ink 680. As anilox roll 630 rotates, doctor blade 640 may be used to remove excess ink 680 from anilox roll 630. In transfer area 690, anilox roll 630 rotates transferring ink 680 from some of the cells to counter rotating flexographic printing plate 660. Flexographic printing plate 660 may include a contact surface formed by distal ends of an image formed in flexographic printing plate 660. The distal ends of the image are inked to transfer an image to transparent substrate 410. The cells may meter the amount of ink 680 transferred to flexographic printing plate 660 to a near uniform volume. In certain embodiments, ink 680 may be a precursor, or catalytic, ink that serves as a plating or buildup seed layer suitable for metallization by electroless plating, immersion bathing, or other buildup processes. For example, ink 680 may be a catalytic ink that comprises one or more of silver, nickel, copper, palladium, cobalt, platinum group metals, alloys thereof, or other catalytic particles. In other embodiments, ink 680 may be a conductive ink suitable for direct printing of conductive lines or features on transparent substrate 410. In still other embodiments, ink 680 may be a non-catalytic and non-conductive ink. For example, ink 680 may be a dielectric ink that is not catalytic and is not susceptible to metallization. One of ordinary skill in the art will recognize that the composition of ink 680 may vary based on an application or a design in accordance with one or more embodiments of the present invention.

Printing plate cylinder 650 may be constructed of a rigid cylinder composed of a metal, such as, for example, steel. Flexographic printing plate 660 may be mounted to a curved contact surface about the body of printing plate cylinder 650 by an adhesive (not shown). Transparent substrate material 410 may be guided by one or more guide rollers 605 to direct the web path as the substrate 410 moves between flexographic printing plate 660 and counter rotating impression cylinder 670. Impression cylinder 670 may be constructed of a rigid cylinder composed of a metal that may be coated with an abrasion resistant coating. As impression cylinder 670 rotates, it applies pressure between substrate 410 and flexographic printing plate 660, transferring an ink 680 image from flexographic printing plate 660 onto substrate 410 at transfer area 695. The rotational speed of printing plate cylinder 650 may be synchronized to match the speed at which the substrate material 410 moves through the flexographic printing station 600. The speed may vary between 20 feet per minute to 3000 feet per minute. After an ink 680 image is printed on a portion of the roll-to-roll substrate material 410, a curing lamp 697, such as, for example, an ultraviolet (“UV”) lamp, may be used to cure the printed ink 680 immediately after printing, but prior to the printed portion of the roll-to-roll substrate material 410 exiting the station 600.

In certain embodiments, one or more flexographic printing stations 600 may be used to print a precursor, or catalytic, ink 680 image (not shown) of one or more conductive patterns (e.g., first conductive pattern 420 or second conductive pattern 430) on one or more sides of one or more transparent substrates 410 as part of a process of fabricating a touch sensor. Subsequent to flexographic printing, the precursor, or catalytic, ink 680 image (not shown) may be metallized by one or more of an electroless plating process, an immersion bathing process, and/or other buildup processes, forming one or more conductive patterns (e.g., first conductive pattern 420 or second conductive pattern 430) on one or more sides of one or more transparent substrates 410. In other embodiments, one or more flexographic printing stations 600 may be used to directly print a conductive ink 680 image (not shown) of one or more conductive patterns (e.g., first conductive pattern 420 or second conductive pattern 430) on one or more sides of one or more transparent substrates 410.

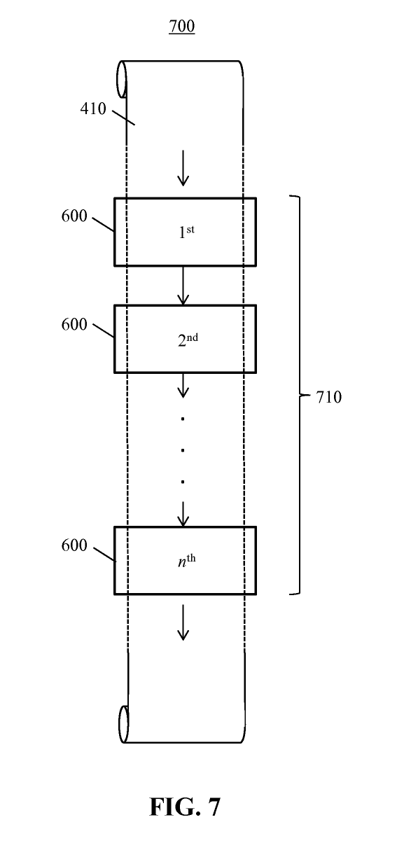

FIG. 7 shows a schematic of a multi-station flexographic printing system 700 in accordance with one or more embodiments of the present invention. In certain embodiments, a multi-station flexographic printing system 700 may include a plurality 710 of flexographic printing stations 600 that are configured to print on one or more sides of a substrate 410 in sequential order. In applications where the multi-station flexographic printing system 700 is configured to print on opposing sides of the same substrate, one or more of the plurality of flexographic printing stations 600 may be configured to print on a first side of substrate 410 and one or more of the plurality of flexographic printing stations 600 may be configured to print on a second side of substrate 410. In other embodiments, a multi-station flexographic printing system 700 may include a plurality 710 of flexographic printing stations 600 where only a subset of the plurality 710 of flexographic printing stations 600 are configured to print on one or more sides of a substrate 410 in sequential order. One of ordinary skill in the art will recognize that the configuration of multi-station flexographic printing system 700 may vary based on an application or design in accordance with one or more embodiments of the present invention.

Multi-station flexographic printing system 700 may include a number, n, of flexographic printing stations 600 where n varies based on an application or design. In certain embodiments, a first flexographic printing station (1^{st} 600 of FIG. 7) may be used to print a non-catalytic ink (680 of FIG. 6) image on substrate, in an area outside a designated image area, of, for example, one or more bearer bars (not shown) and/or one or more optical registration marks (not shown) that may be used to control the press during flexographic printing operations. The number, n−1, of subsequent flexographic printing stations (2^{nd} through n^{th} 600 of FIG. 7) may also vary based on an application or design. In certain embodiments, the number of subsequent flexographic printing stations 600 may include at least one flexographic printing station 600 for each side of substrate 410 to be printed. In other embodiments, the number of subsequent flexographic printing stations 600 may include a plurality of flexographic printing stations 600 for each side of substrate 410 to be printed. In still other embodiments, the number of subsequent flexographic printing stations 600 may include a plurality of flexographic printing stations 600 for each side of substrate 410 to be printed, where the number of flexographic printing stations 600 for a given side may be determined by the number of micrometer-fine lines or features to be printed having a different width or orientation.

For example, in certain touch sensor embodiments, multi-station flexographic printing system 700 may be configured to print an image of a first conductive pattern (e.g., first conductive pattern 420) on a first side of transparent substrate 410 and an image of a second conductive pattern (e.g., second conductive pattern 430) on a second side of transparent substrate 410. The image of the first conductive pattern may include an image of a plurality of parallel conductive lines oriented in a first direction (e.g., 505 of FIG. 5A), an image of a plurality of parallel conductive lines oriented in a second direction (e.g., 510 of FIG. 5A), and an image of bezel circuitry (e.g., 540, 550, and 560 of FIG. 5A). The image of the second conductive pattern may include an image of a plurality of parallel conductive lines oriented in a first direction (e.g., 520 of FIG. 5B), an image of a plurality of parallel conductive lines oriented in a second direction (e.g., 525 of FIG. 5B), and an image of bezel circuitry (e.g., 540, 550, and 560 of FIG. 5B).

Continuing with the example, a first flexographic printing station (1^{st} 600 of FIG. 7) may be configured to print a non-catalytic ink (680 of FIG. 6) image on a first side of transparent substrate 410, a second flexographic printing station (2^{nd} 600 of FIG. 7), a third flexographic printing station (3^{rd} 600 of FIG. 7), and a fourth flexographic printing station (4^{th} 600 of FIG. 7) may be configured to print a catalytic ink (680 of FIG. 6) image of a first conductive pattern (e.g., first conductive pattern 420) on the first side of transparent substrate 410, and a fifth flexographic printing station (5^{th} 600 of FIG. 7), a sixth flexographic printing station (6^{th} 600 of FIG. 7), and a seventh flexographic printing station (7^{th} 600 of FIG. 7) may be configured to print a catalytic ink (680 of FIG. 6) image of a second conductive pattern (e.g., second conductive pattern 430) on a second side of transparent substrate 410. One of ordinary skill in the art will recognize that the number and configuration of flexographic printing stations 600 of multi-station flexographic printing system 700 may vary based on an application or design in accordance with one or more embodiments of the present invention.

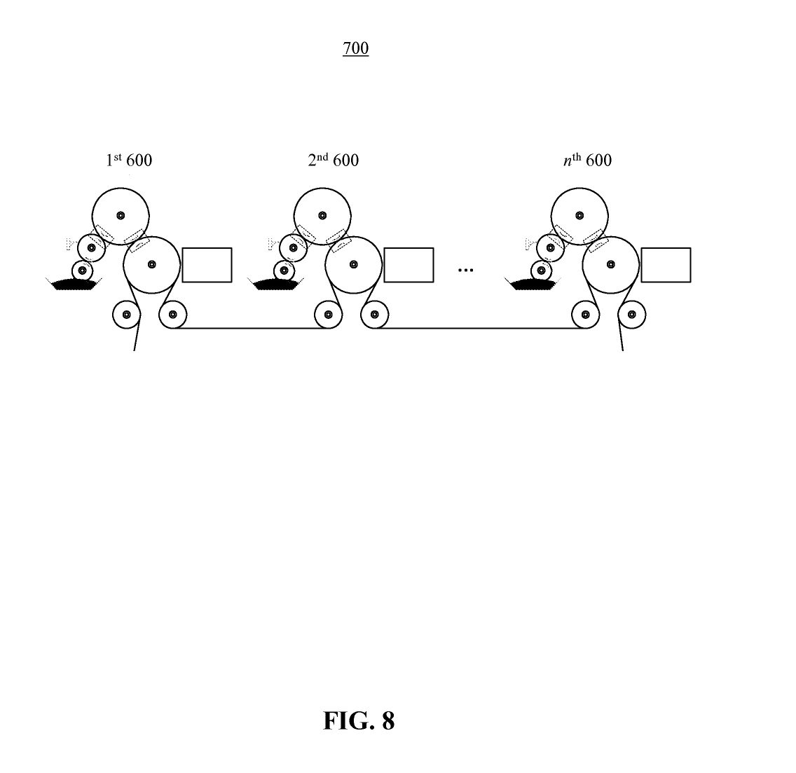

FIG. 8 shows a roll-to-roll substrate material 410 path in a multi-station flexographic printing system 700 in accordance with one or more embodiments of the present invention. Multi-station flexographic printing system 700 may include a number, n, of flexographic printing stations 600 that may vary based on an application or design. Roll-to-roll substrate material 410 proceeds through each flexographic printing station 600 as described with respect to FIG. 6 and the substrate material 410 is then routed by one or more guide rollers (e.g., 605 of FIG. 6) to the next flexographic printing station 600 in the system 700. This process continues until the substrate material 410 exits the last flexographic printing station 600 of the system 700, thereby completing flexographic printing operations.

Advantageously, a roll-to-roll flexographic printing station allows for the printing of complex patterns on a single side of a substrate material during flexographic printing operations. Multi-station flexographic printing systems further that capability and allow for the printing of even more complex patterns on one or both sides of a substrate at a high speed limited by the speed of the system. However, flexography is not effective as a coating deposition process for a number of reasons. Typical coating compositions include a principal resin that serves as the film forming component of the coating composition. Low viscosity resins are desirable because they flow by themselves and planarize the surface they are deposited on. However, because of the high speed of the flexographic printing process, a flexographically printed resin or coating is cured at the same station, immediately after printing at that station, without time for flow, planarization, and coverage of the area of interest. As a consequence, flexographically printed resins or coatings tend to increase the haze of the substrate and reduce the ability of the substrate to transmit an underlying image, such as, for example, an image displayed on a display device. Because conventional flexography is not suitable for use in the deposition of a resin or coating, other coating deposition processes must be employed such as, for example, gravure printing, reverse gravure printing, and/or slot die coating. While slot die coating is suitable for coating lanes of substrate, it is not suitable for the deposition of a coating in a detailed pattern at a high speed. As such, there is no conventional method of applying a coating composition in a detailed pattern in a high volume manufacturing environment.

Accordingly, in one or more embodiments of the present invention, a multi-station flexographic printing system for patterned coating deposition allows for the deposition of resin and other coating compositions in a detailed pattern at flexographic printing speeds that improves the optical qualities of the deposited coating and/or the substrate on which it is deposited. For example, a multi-station flexographic printing system for patterned coating deposition may be used to deposit a radiation-curable optically clear coating composition, as set out in U.S. patent application Ser. No. 14/727,818, filed on Jun. 1, 2015, on touch sensors in a detailed pattern that, for example, corresponds to a conductive pattern at flexographic printing speeds.

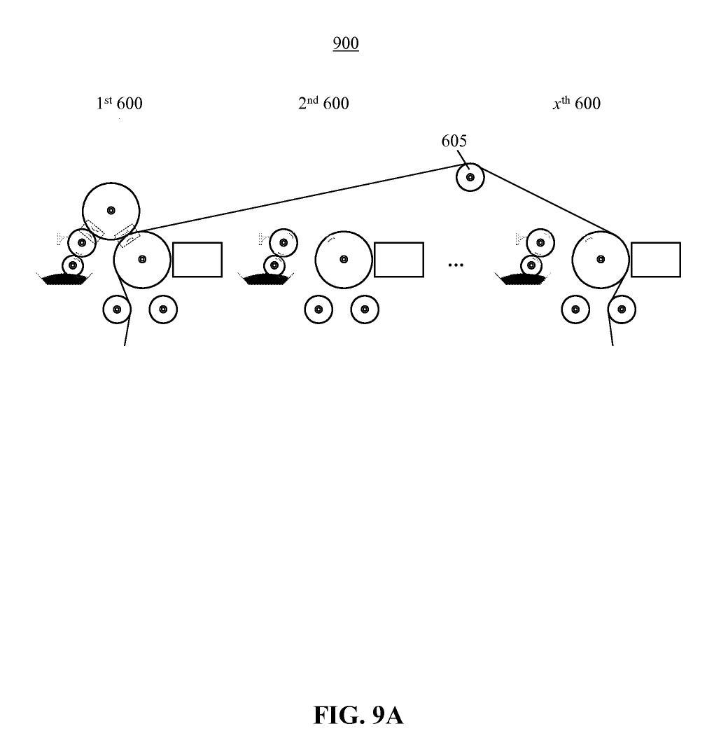

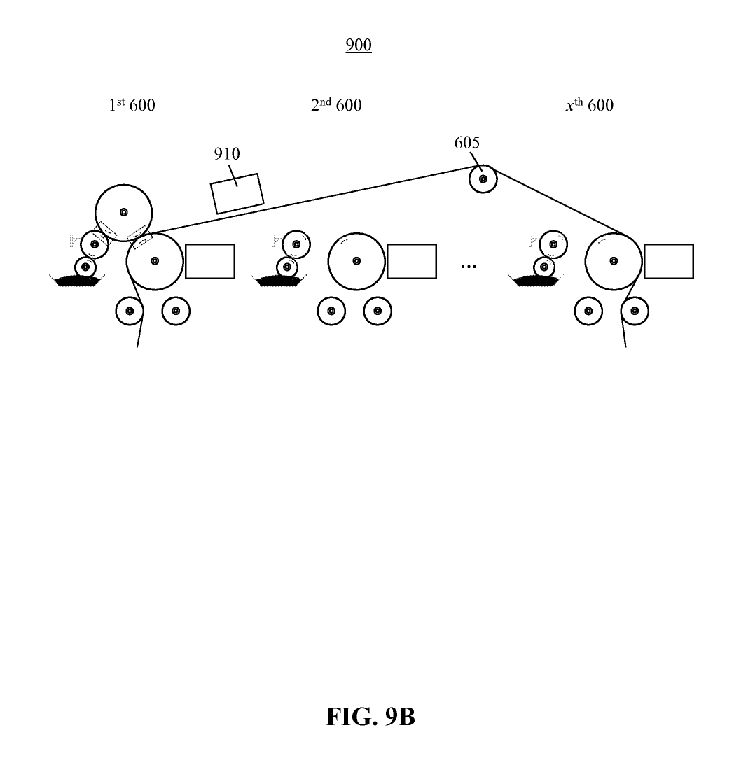

FIG. 9A shows a modified roll-to-roll substrate 410 path in a multi-station flexographic printing system for patterned coating deposition 900 in accordance with one or more embodiments of the present invention. A multi-station flexographic printing system for patterned coating deposition 900 may be formed by modifying an existing multi-station flexographic printing system (e.g., 700 of FIG. 7) or constructing a multi-station flexographic printing system where the roll-to-roll substrate 410 path is modified such that the substrate 410 printed at, for example, a first flexographic printing station 1^{st} 600 is not cured at that first station, but is cured at a subsequent station (e.g., one of 2^{nd}, 3^{th}, or x^{th} 600). In this way, the system 900 may continue to print at flexographic printing speeds without delay and a user defined delay may be imposed between printing and curing by selection of one station to print and a subsequent station to cure. In the embodiment depicted in the Figure, a first flexographic printing station 1^{st} 600 may print a resin or coating on substrate 410 in a detailed pattern, but the web path is modified such that the substrate 410 bypasses the curing portion of the first flexographic printing station 1^{st} 600 and is directed by one or more guide rollers 605 to a subsequent flexographic printing station (e.g., one of 2^{nd}, 3^{th}, or x^{th} 600) where the substrate is not printed, but is cured. One of ordinary skill in the art, having the benefit of this disclosure, will recognize that the amount of delay between printing and curing may be controlled by selection of a station to print and selection of a subsequent station to cure as well as control of the speed of the system 900.

FIG. 9B shows a modified roll-to-roll substrate 410 material path in a multi-station flexographic printing system for patterned coating deposition 900 with an optional infrared heater 910 in accordance with one or more embodiments of the present invention. In certain embodiments, an optional infrared heater 910 may be used to planarize, or smooth, the coating after printing, but prior to radiation curing.

One of ordinary skill in the art will recognize that, while FIGS. 9A and 9B show printing and curing of a single side of roll-to-roll substrate 410 material, multi-station flexographic printing system for patterned coating deposition 900 may be used to print on both sides of substrate 410 in accordance with one or more embodiments of the present invention.

Advantages of one or more embodiments of the present invention may include one or more of the following:

In one or more embodiments of the present invention, a multi-station flexographic printing system for patterned coating deposition allows for the use of a multi-station flexographic printing system to deposit a resin or coating in a detailed pattern on one or both sides of a substrate at a high speed consistent with flexographic printing operations.

In one or more embodiments of the present invention, a multi-station flexographic printing system for patterned coating deposition allows for introduction of predetermined amount of delay between flexographic printing and curing without pausing the flexographic printing system. Advantageously, the system may apply a resin or coating in a detailed pattern on one or both sides of a substrate at a high speed suitable for high volume manufacturing.

In one or more embodiments of the present invention, a multi-station flexographic printing system for patterned coating deposition allows for the printed resin or coating to flow, planarize, and cover the area of interest prior to curing.

In one or more embodiments of the present invention, a multi-station flexographic printing system for patterned coating deposition is compatible with existing roll-to-roll printing processes.

In one or more embodiments of the present invention, a multi-station flexographic printing system for patterned coating deposition is compatible with existing multi-station flexographic printing systems.

In one or more embodiments of the present invention, a multi-station flexographic printing system for patterned coating deposition may be implemented on an existing multi-station flexographic printing system.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of depositing a patterned coating in a multi-station flexographic printing system comprising:
printing a coating in a pattern on a roll-to-roll substrate material with a first flexographic printing station;
routing the printed roll-to-roll substrate material from the first flexographic printing station to a subsequent flexographic printing station; and
curing the printed roll-to-roll substrate material at the subsequent flexographic printing station.

2. The method of claim 1, further comprising planarizing the printed coating with an infrared heater.

3. The method of claim 1, wherein the subsequent flexographic printing station is selected to impose a predetermined amount of delay between printing at the first flexographic printing station and curing at the subsequent flexographic printing station.

4. The method of claim 1, wherein a curing portion of the first flexographic printing station is bypassed.

5. The method of claim 1, wherein a printing portion of the subsequent flexographic printing station is bypassed.

6. A multi-station flexographic printing system for patterned coating deposition comprising:
a first flexographic printing station;
a subsequent flexographic printing station; and
at least one guide roller configured to route a roll-to-roll substrate material from a printing portion of the first flexographic printing station to a curing portion of the subsequent flexographic printing station,
wherein the first flexographic printing station prints a coating in a pattern on the roll-to-roll substrate material and the subsequent flexographic printing station cures the printed coating.

7. The system of claim 6, further comprising an infrared heater configured to planarize the printed coating.

8. The system of claim 6, wherein the subsequent flexographic printing station is selected to impose a predetermined amount of delay between printing at the first flexographic printing station and curing at the subsequent flexographic printing station.

9. The system of claim 6, wherein a curing portion of the first flexographic printing station is bypassed.

10. The system of claim 6, wherein a printing portion of the subsequent flexographic printing station is bypassed.
